(19) United States
(12) Patent Application Publication
(10) Pub. No.: US 2021/0149948 A1
(43) Pub. Date: May 20, 2021

(54) GENERATION OF OBJECT DATABASES

(71) Applicant: Hewlett-Packard Development Company, L.P., Spring, TX (US)

(72) Inventor: Vijaykumar Nayak, San Diego, CA (US)

(73) Assignee: Hewlett-Packard Development Company, L.P., Spring, TX (US)

(21) Appl. No.: 17/047,457

(22) PCT Filed: Oct. 11, 2018
(86) PCT No.: PCT/US2018/055382

§ 371 Date: Oct. 14, 2020

(51) Int. Cl. G06F 16/55; G06F 16/54; G06F 16/532; G06F 16/538; G06K 9/62; G06N 3/08

(52) U.S. Cl. CPC G06F 16/55; G06F 16/54; G06N 3/08; G06F 16/538; G06K 9/6256; G06F 16/532

(57) ABSTRACT

A system may include a scanning device to scan a plurality of objects in a controlled environment and in multiple orientations, a scan calibrator to perform calibration of the scanning by the scanning device, and a database configurator. The database configurator may be configured to determine multi-dimensional invariant orientations and geometric properties of features of the scanned objects to generate subsets of objects from the plurality of objects that are unique to the subset of objects, determine correlations between the determined multi-dimensional invariant orientation and the geometric properties of the features, generate group identifiers for each of the subsets of objects, perform supervised training on the determined multi-dimensional invariant orientations and geometric properties to generate trained parameters for each of the subsets of objects, and generate an object database based on the group identifiers and the trained parameters.

### BACKGROUND

Object databases may be generated based on two-dimensional (2D) and three-dimensional (3D) features of the objects. Object databases may be utilized to store information regarding the features and other information for a relatively large number of physical objects in a searchable manner. An object may be identified within the database by performing an object look up of an object from within the generated object database.

### BRIEF DESCRIPTION OF THE DRAWINGS

FIG. 1 is a schematic diagram of an example of an object database generation system consistent with the present disclosure.

FIG. 2 is a schematic diagram illustrating an example of a system for generating an object database consistent with the present disclosure

FIG. 3 is a flowchart of an example of a method of generating an object database consistent with the present disclosure.

FIG. 4 is a flowchart of an example of a method of generating an object database consistent with the present disclosure.

FIG. 5 is a schematic diagram of an example of an identification of an object from an object database generated consistent with the present disclosure.

FIG. 6 is a flowchart of an example of a method of identifying an object from an object database consistent with the present disclosure,

FIG. 7 is a schematic diagram of an example of an identification of an object from an object database generated in accordance with the present disclosure.

FIG. 8 is a flowchart of an example of a method of generating an object database consistent with the present disclosure.

### DETAILED DESCRIPTION

Object databases may be utilized to organize and/or store searchable information regarding objects based on their 2D and 3D features. As a quantity of objects in the database scales, so too may the computational complexity involved in structuring and/or utilizing the database. For example, identifying a searched-for object in a database may involve detecting the object or objects matching the search in the database within a threshold level of accuracy.

The object database may be generated using supervised training methods. For example, the object database may be generated utilizing convolutional neural network (CNN) processes. These supervised training models may utilize supervised machine learning methods, predominantly, deep learning. However, as noted above, as the number of objects that are included in the object database increases, the complexity of the training provided by the supervised machine learning methods also increases. As the complexity increases, the computational burden (e.g., number of operations, amount of computing resources consumed, time to completion, etc.) of the training process may also increase.

As such, when the number of objects in a database surpasses a threshold amount, the accuracy in operations such as searches of the database may be reduced by limited available computational resources and/or limitations of trained models to identify searched-for features. Accordingly, the accuracy of such supervised training methods decreases as the number of objects in the object database increases.

In contrast, examples of the present disclosure may generate and/or utilize staged feature filtering including computer-vision based heuristic and/or stochastic techniques and/or including a neural network based pre-trained network of subsets of similar objects. As a result, the present disclosure increases accuracy in identifying a matching object from a relatively large number of objects in a database and reduces the computational burden of performing such searches. For example, an example of a system consistent with the present disclosure may include a scanning device to scan a plurality of objects in a controlled environment and in multiple orientations. The system may include a scan calibrator to perform a calibration of the scanning by the scanning device. The system may include a database configurator to determine multi-dimensional invariant orientations and geometric properties of features of the scanned objects to generate subsets of objects from the plurality of objects that are unique to the subset of objects, determine correlations between the determined multi-dimensional invariant orientation and the geometric properties of the features, generate group identifiers for each of the subsets of objects, perform supervised training on the determined multi-dimensional invariant orientations and geometric properties to generate trained parameters for each of the subsets of objects, and generate an object database based on the group identifiers and the trained parameters.

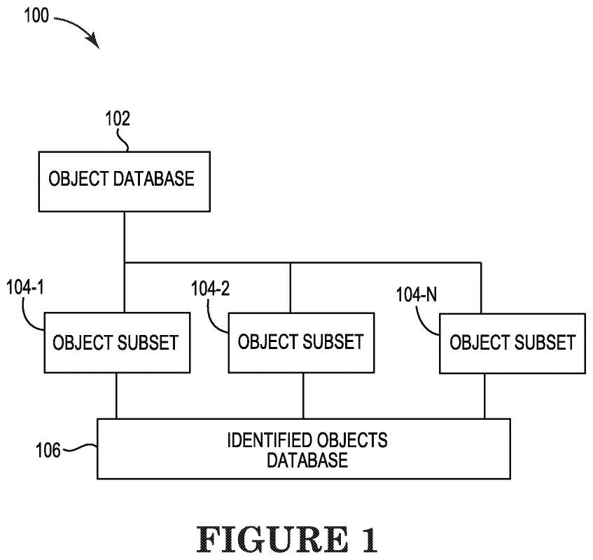

FIG. 1 is a schematic diagram of an example of an object database 102 generation system 100 consistent with the present disclosure. An object database 102 may include a data structure. The data structure may include an organized collection of data, stored and accessible electronically. The data may include data corresponding to and/or describing physical objects. That is, the object database 102 may be a database of information regarding physical objects. For example, the object database 102 may include object data such as physical characteristics of the physical objects in addition to organizational data such as part number, stock keeping unit (SKU), quantity in stock, etc. corresponding to the physical objects.

As described above, object data may include physical characteristics of each object stored in the database. Such object data within the object database 102 may be utilized to organize and/or model real world physical and geometric characteristics of each of the objects. For example, the object data may be utilized to model the characteristics of each of the objects to a format that is utilizable to perform processes within the object database 102. For example, the object data may be utilized to model the characteristics of each of the objects stored in the object database 102 to a format that may be utilized to answer an object or part identification request, including performing an object identification search based on real world characteristic search parameters.

The object database 102 may be generated from an existing database of objects. For example, an object database 102 may be generated from an existing database of physical objects such as an automotive object database containing automotive parts, an object database containing various screws, an object database containing various fasteners, etc.

During the generation of an object database 102 each physical object or corresponding database entry already existing in another database may be scanned by a two-dimensional (2D) and/or a three-dimensional (3D) scanner. The data resulting from the scan may be analyzed and common features of subsets of the objects may be identified. That is, the scan data may be analyzed to determine multi-dimensional invariant orientations and geometric properties of features of the scanned objects to identify subsets of objects from the plurality of objects that are unique to the subset of objects. For example, groups of objects such as fasteners with a same or similar length, thread pitch, thread diameter, shank diameter, root diameter, head size, etc. may be identified among the scanned objects.

Based on the identified common features of the objects, multiple subsets of objects 104-1 . . . 104-N may then be generated from the scanned objects. For example, multiple subsets of objects 104-1 . . . 104-N may be generated that include multi-dimensional invariant orientations and geometric properties of features of the scanned objects that are unique to the subset of objects 104-1 . . . 104-N relative to the overall database of objects 102.

The identified multiple subsets may be utilized to generate an identified objects database 106. For example, correlations between the determined multi-dimensional invariant orientation and the geometric properties of the features may be determined and group identifiers for each of the subsets of objects 104-1 . . . 104-N may be generated. Supervised training may be performed on the determined multi-dimensional invariant orientations and geometric properties to generate trained parameters for each of the subsets of objects 104-1 . . . 104-N. An identified object database 106 may be generated based on the group identifiers and the trained parameters. The identified object database 106 may be utilized as part of a relatively more constrained identification scheme for subsequent object identification requests, as described in greater detail below.

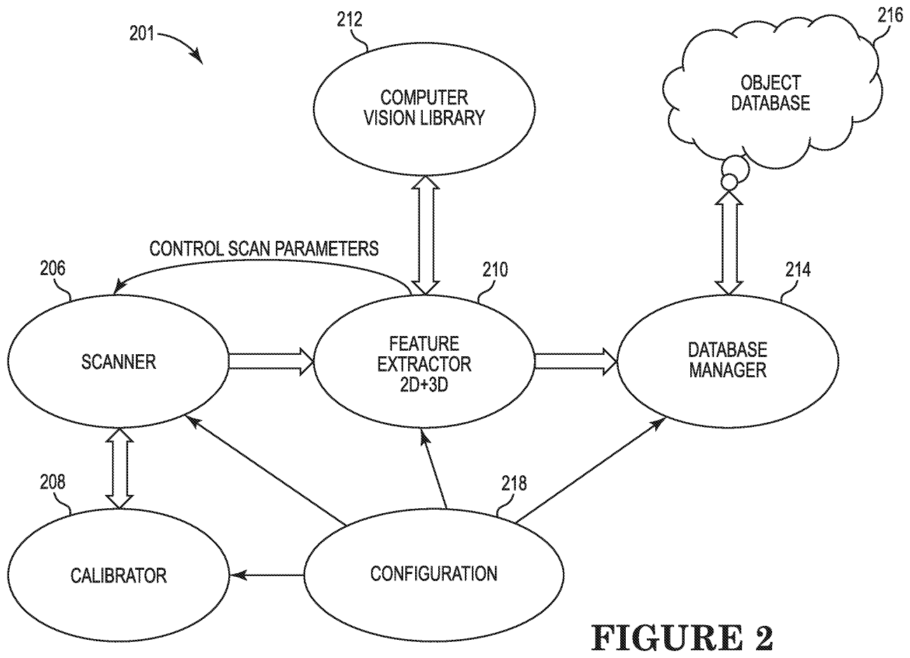

FIG. 2 is a schematic diagram illustrating an example of a system 201 for generating an object database 216 consistent with the present disclosure. The system 201 may include a database generation device. A database generation device may include a processing resource and a memory resource. The memory resource may store instructions executable by the processing resource to execute various operations described in relation to performing the generation of the object database 216.

Generating an object database 216 may include capturing each of a plurality of objects that are to be included in the object database 216. Capturing the objects may include capturing digital images or other digital representations of the physical form and/or properties of each object using a scanning device 206. A scanning device may include a camera, such as a 2D-3D digital camera, and/or other object visualizing sensors. The scanning device may perform scanning of the object (e.g., capture the images or other data of the object) while the object is in known controlled environmental conditions.

During generation of the object database 216 from an existing database of objects that are to be included in the object database, the scanning device 206 may be calibrated by a scan calibrator 208. The scan calibrator 208 may confirm and/or adjust environmental conditions such that each of the objects may be captured via the cameras of the scanning device 206 under the controlled environmental conditions. For example, the scan calibrator 208 may confirm that specified proper controlled lighting conditions are utilized when capturing images of the object and/or may adjust lighting conditions to the specified proper conditions prior to each scan of the object.

For example, when multiple light sources are present in the physical environment where the physical object is being scanned, the light sources may be adjusted and/or controlled to achieve a specified controlled lighting condition. Likewise, a camera orientation during scanning of each of the objects or parts to be included in the generated objected database 216 may be controlled and/or adjusted to achieve a specified camera orientation and/or specified controlled lighting condition. Additionally, the scan calibrator 208 may control and/or adjust certain geometric properties that may affect scanning, such as a distance metric or a length metric for example, associated with the capture of each of the objects by the scanning device 206 and as a result achieve consistent scans relative to environmental conditions across scanned objects.

For example, a feature extractor 210 may extract 2D-3D features from each of the objects being scanned. For example, the feature extractor 210 may extract features such as a length of the object, width of the object, convex hull of the object, contour, centroid of the object, various color features of the object, cross-sectional area of the object, etc. from each of the objects. The extracted 2D-3D features may be utilized to control scan parameters utilized during scanning to generate the controlled environmental and geometric conditions during the generation of the object database.

The extracted features of each of the objects may be obtained using a computer vision library 212, rather than through vision learning being applied to the scanning process. A computer vision library may include a library of functions executable by a processing resource to perform substantially real-time feature extraction from the scanned object. In either case, the extracted features may be stored in a data manager 214 along with the 2D-3D snapshots of each of the objects that are obtained.

A configurator device 218 may be utilized to change the nature of the 2D-3D feature extraction based on a type of issue that the configurator device 218 is attempting to adjust conditions to address. For example, the configurator device 218 may change the settings of the scanner based on the type of object that is being scanned. For example, the configurator device 218 may determine whether a 3D camera should be utilized to perform the scan of the object, whether a time-of-flight camera should be utilized to perform the scan of the object, whether a high-resolution scanner should be utilized to scan the object, etc. based on the type of object and the data that the scan is attempting to capture about the object. That is, for each of the subdomains of part identification, a configuration of the scan type or scan parameters may be adjusted by the configurator device 218 based on an object type or the type of object identification that is being performed. Because a controlled environment is utilized to collect the scan, such configuration settings are controllable and non-arbitrary. As such, the configurator 218 may adjust the scan collection parameters so that particular settings can be applied that are specifically tailored to a particular class of objects.

In this way, the scanning device 206, scan calibrator 208, feature extractor 210 and database manager 214 may be controlled by a configurator device 218 to orchestrate collection of object scans in a controlled manner and generate an object database 216 containing the 2D-3D snapshots for each of the objects, including the orientations and geometries of the objects under controlled lighting conditions, along with the various extracted features that are extracted from the objects, as described below. These snapshots, orientations and geometries, and extracted features of the objects may then be utilized to generate an accelerated object database from a larger database of objects that may subsequently be used to identify each object when an object identification request is received.

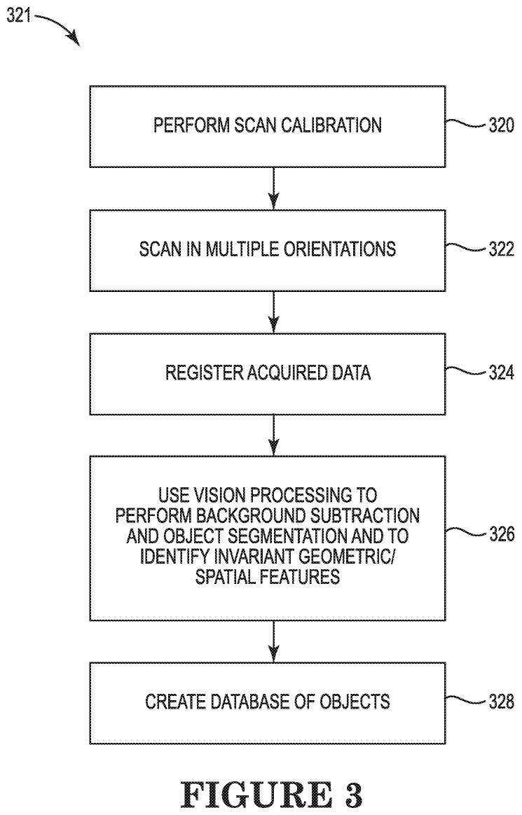

FIG. 3 is a flowchart of an example of a method 321 of generating an object database consistent with the present disclosure. In some examples, the method 321 may include a first stage of the generation an object data base from an existing dataset of objects. At 320, the method 321 may include performing a scan calibration of a scanning by the scanning device (e.g., scanning device 206 FIG. 2) to identify scale, skew and perspective of the scanned image for each of the objects.

At 322, the method 321 may include scanning of the object or part by the scanning device utilizing multiple orientations. Scanning the object in multiple orientations may be utilized to acquire multidimensional scan features such as RGB (red, green and blue) data, IR (infrared) absorption data and depth data.

At 324, the method 321 may include registering the acquired data. For example, the data acquired from the multiple orientation scans may be registered. Registering the data may facilitate the comparison and/or integration of the multidimensional scan features obtained from different measurements. In some examples, a targeted level of quality and/or resolution of the scan may not be achieved utilizing an initial set of scanning parameters. In such examples, a high-resolution 3D scan may also be performed during the scanning of the objects. In this way, since the multidimensional aspects of each of the scanned objects are identified during generation of the object database and registered in a controlled environment, pixel correspondences between the scanned images may be identified and mapped to enable improved analysis of the scanned images of the objects for subsequently identifying an object during the generated object identification scheme. Similarly, knowledge of the position of the cameras of the scanners, or the knowledge of depth features of each scan may facilitate analysis of global common features of the objects that may be utilized to generate the object identification scheme for subsequently identifying the objects, described below.

At 326, the method 321 may include utilizing one or more vision processing procedures to perform a background subtraction. A vision processing procedure may include operations to process an image of an object and perform operations to separate, extract, identify, etc. portions of the image. Having such a controlled scanning environment may further facilitate one or more vision processing procedures to be utilized. Likewise, the one or more vision processing procedures may be utilized to identify invariant geometric and/or spatial features of the scanned object. Such vision processing may be utilized to perform adjustments to fix and adjust the scale, skew orientation and perspective of each of the scanned objects to reduce distortions in the way the object is acquired. As a result, the scanning and feature acquisition may be more uniform across various scanning captures during generation of the object database. In addition, such vision processing may facilitate an accurate and complete background subtraction and object segmentation to be performed since knowledge of the background is known beforehand as a result of the controlled scanning environment, i.e., controlling background and lighting conditions.

Knowledge of the class of objects and associated common features may be known during the object database generation. Such known common features may also be utilized to determine a unique set of features of an object, a class of objects, and/or a subset of a plurality of scanned objects. The features may then be utilized for scanning that class of objects. For example, a length and/or width of the objects may be utilized so that a corresponding class of objects may include a number of possible geometric transforms that are relied upon for use during the scanning of the objects. For example, for a class of parts identified as being screws, length may be a geometric feature that could be used to identify the objects. In one example, one or more of the common features of the objects may be specified through user input so that the result is more deterministic and closer to a ground truth associated with the accuracy of the training set's classification for supervised learning techniques. Therefore, invariant and geometric/spatial features may be identified through vision processing procedures or through a high-resolution scan. The geometric and/or spatial features may be utilized to generate a 3D model to obtain as many geometric properties of the object as possible. In examples, averaging over multiple scans may also be performed. Such averaging may reduce variants in the background subtracting and object segmentation.

At 328, the method 321 may include storing the calibrations, scanned images, and parameters corresponding to each of the objects. The stored data may be utilized to generate a database of the objects based on the invariant geometric features obtained as described above. Once the invariant and geometric/spatial features of each of the objects are identified and stored, a catalogue of subsets of objects having highly spatially similar parts or objects may be generated, along with unique group IDs for each group of identified common parts, as described below.

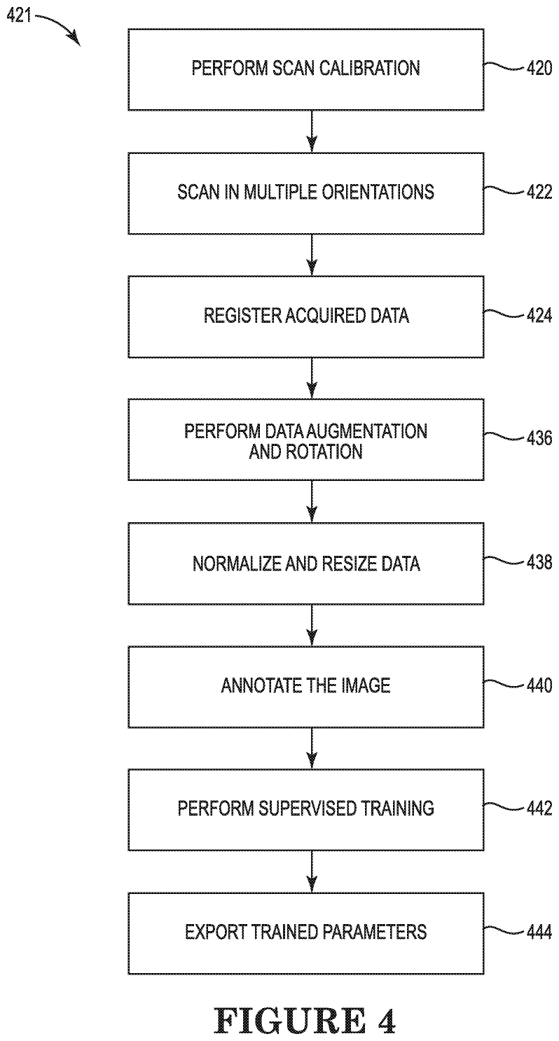

FIG. 4 is a flowchart of an example of a method 421 of generating an object database consistent with the present disclosure. In some examples, the method 421 may include a second stage of the generation an object data base from an existing dataset of objects. At 420, the method 421 may include performing a scan calibration. The scan calibration may be performed for each of the identified common objects within each unique group of objects in a subset of objects. The scan calibration may be utilized to identify scale, skew and perspective of the scanned images of the common objects. Supervised training, such as convolutional neural network training for example, may then performed on the group of common objects within the subsets of objects.

At 422, the method 421 may include scanning each object included within each subset of objects associated with a given group ID in multiple orientations of the object. Corresponding RGB data, IR data, and/or depth data may be acquired from the scans. At block 424, the method 321 may include registering the corresponding RGB data, IR data, and/or depth data that may be acquired from the scans.

At 436, the method 421 may include performing data augmentation on the acquired data. For example, the data may be augmented by scaling, skew flipping, mirroring, cropping, etc.

At 438, the method 421 may include performing a normalization and/or resizing of the data. Additionally, a whitening transformation or sphering transformation may be performed. For example, the data may be transformed utilizing a PCA whitening transformation that changes the input vector into a white noise vector. For example, the PCA whitening transformation may include a linear transformation that transforms a vector of random variables with a known covariance matrix into a set of new variables whose covariance is the identity matrix, meaning that they are uncorrelated, and each have variance 1.

At 440, the method 421 may include annotating the image of the object. For example, the image may be annotated with the corresponding object class formatted as metadata.

At 442, the method 421 may include performing a supervised training. For example, a high-performance CNN training may be performed for the objects. In examples, the objects within the subset of objects may be utilized to perform a CNN training.

At 444, the method 421 may include exporting and storing trained parameters. For example, the resulting data and resulting trained parameters from the CNN training of 442 may be exported and stored in a group table for the group ID corresponding to identification of the subset of objects.

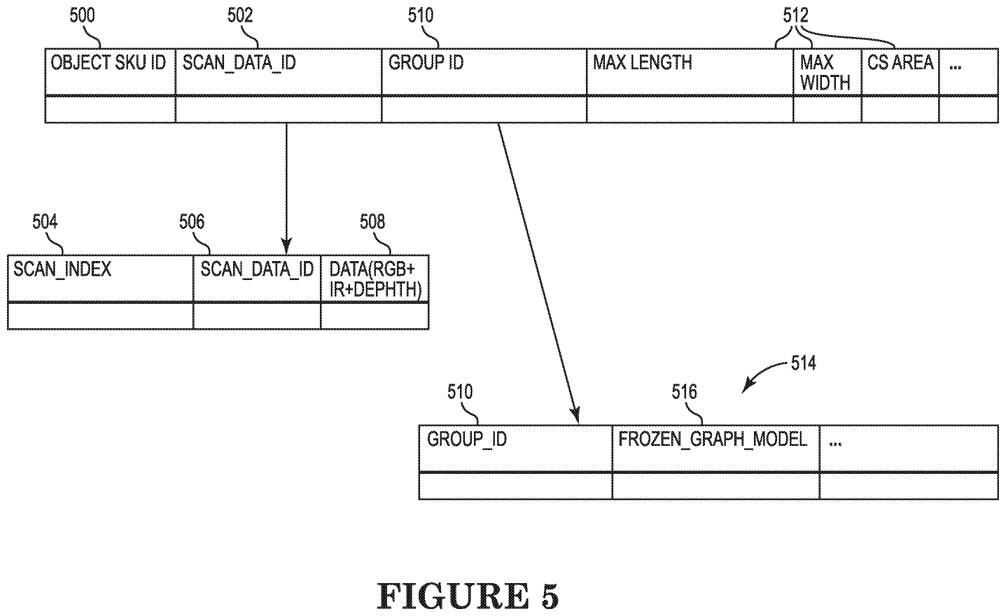

FIG. 5 is a schematic diagram of an example of an identification of an object from an object database generated consistent with the present disclosure. As illustrated in FIG. 5, in order to identify the objects included within the subsets of objects generated as described above, each of the objects included in the generated object database includes an object SKU ID 500. An object SKU ID 500 may identify the object.

Additionally, each of the objects may include a scan data ID 502. The scan data ID 502 for the object may identify the scan data generated during the database generation. For example, the scan data ID 502 may include a scan index 504 associated with the object, a scan data ID 506 that identifies the data that was generated for the object during scanning, and a list of the scan data 508 for the identified scan index 504, such as the corresponding RGB data, IR data and depth data that is acquired for the given identified object.

In addition, each object included in the object database includes a group ID 510. The group ID 510 may include an ID indicating the subset group of objects to which the given object is included based on having the same common features, as described above. Further, a list of the invariant features 512 for a given SKU ID 500 that are utilized for determining the subset group of objects to which the given object is determined to belong, such as maximum length, maximum width, cross-sectional are, etc. may be included.

The group ID 510 may include another table 514 in which the objects included within the identified subset of objects for the indicated group ID 510 are listed. The table 514 may also list the corresponding trained parameters within a frozen graph model 516 resulting from the supervised training being performed on the objects in the given subset of objects, as described above. Each group ID 510 may correspond to objects filtered by one of the invariant features 512 and is therefore a group of objects that is smaller than the group of objects included in the original existing object database.

For example, one group ID 510 may indicate those objects having a length within a certain percentage of a given value, such as within ten percent of eight inches. Further filtering based on the invariant features 512 may be performed to reduce that subset of objects to an even smaller subset of objects, such as performing further filtering of those objects having a given width, resulting in a subset of objects having both a length within a certain percentage of a given value and having a given width. Supervised training would then be performed on this reduced set of objects, as opposed to the supervised training being performed on all of the objects included within a database of all of the objects.

For example, during generation of the object database, three subsets of objects, subset 1, subset 2 and subset 3, may be created based on the determined multi-dimensional orientations and geometric properties of features. For example, subset 1 may be a subset of objects having certain small model features, subset 2 may be a subset of objects having certain large model features, and subset 3 may be a subset of objects having certain medium model features. All of the objects included in subset 1, sm1, sm2, sm3 . . . smN, will include the same group ID 510, and a frozen graph model 516 created as a result of supervised training being performed with the objects within the subset, i.e., sm1, sm2, sm3 . . . smN as inputs. Similarly, all of the objects included in subset 2, lm1, lm2, lm3 . . . smN, will include the same group ID 510, and a frozen graph model 516 created as a result of supervised training being performed with the objects within the subset, i.e., lm1, lm2, lm3 . . . lmN as inputs, and all of the objects included in subset 3, mm1, mm2, mm3 . . . mmN, will include the same group ID 510, and a frozen graph model 516 created as a result of supervised training being performed with the objects within the subset, i.e., mm1, mm2, mm3 . . . mmN as inputs.

In this way, by reducing the number of objects included in the supervised training to only those common objects included in the identified groups, the present disclosure reduces training time during the supervised training and increases the accuracy of the supervised training. For example, if the original number of objects included in the object database prior to generation of the object database according to the present disclosure includes 10,000 data objects, the object database generation of the present disclosure may generate a number of groups of unique highly spatially similar objects, such as 50 groups of similar objects, for example, each containing a number of data objects that is significantly less than the original 10,000 data objects of the original database, and performing supervised training separately on each group, so that the training is performed on a reduced number of objects, resulting in increased accuracy.

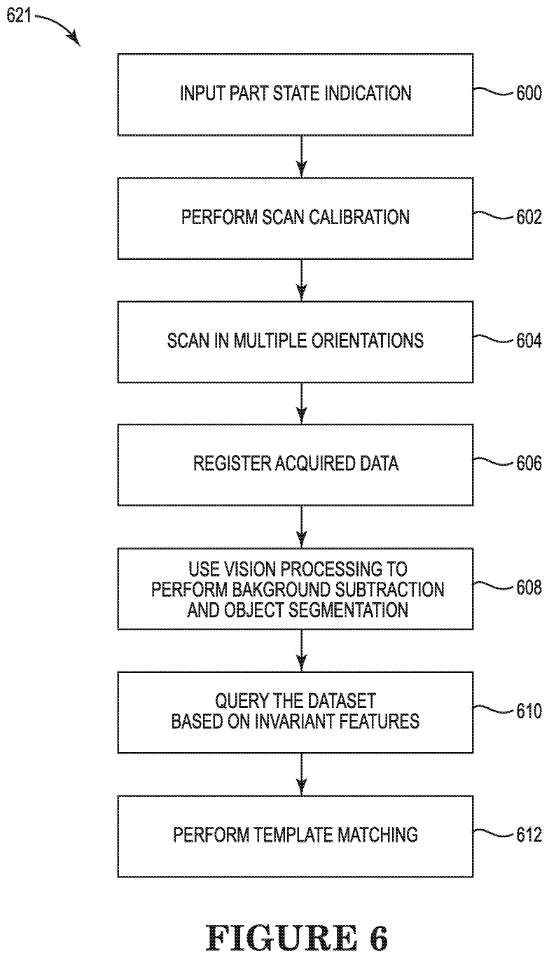

FIG. 6 is a flowchart of an example of a method 601 of identifying an object from an object database consistent with the present disclosure. The method 601 may include a subsequent identification of an object using the object database generated in accordance with the database generation described above. A subsequent identification of an object may include an identification of an object occurring after an initial and/or previous identification. For example, a subsequent identification may include an identification of a part that has occurred after a previous identification of the part and/or after a use of the part that occurred subsequent to the previous identification.

At 600, the method 601 may include receiving an input including a designation of a state identification of the object to be scanned. For example, during a subsequent identification of an object using the object database generated in accordance with the database generation scheme described above, a user may input a state or condition of the object based on predetermined stages of degradation. For example, if the object is almost intact without any wear, the user may generate an input indicating that the object is considered by the user to be in a good condition. If the object has some wear and tear, the user may generate an input indicating that the object is considered by the user to be a complete object in an average condition. On the other hand, if the object is broken or is an incomplete object, the user may generate an input indicating the object is considered by the user to be in a bad condition.

At 602, the method 601 may include, for those objects that the user inputs an indication that the object is in either a good condition or an average condition, performing a scan calibration. A scan calibration may calibrate scale, skew and perspective of the image during scanning.

At 604, the method 601 may include scanning the object in multiple orientations. The scan may acquire data such as corresponding RGB data, IR data and depth data for each of the scanned objects. At 606, the method 601 may include registering the acquired data.

At 608, the method 601 may include utilizing vision processing to perform background subtraction and object segmentation. For example, a CNN technique may be utilized to perform background subtraction and object segmentation which enables the object to be identified using an iterative process to generate accurate segmentation at high signal to noise ratio SNR. The vision processing procedures may be performed to subsequently fix the scale, skew orientation and perspective of the scanned object using an aligned axis, and to identify invariant and geometric/spatial feature vectors, such as maximum length, maximum width, cross-sectional area, centroid, convex hull, contour, etc. In addition, averaging may be performed over multiple scans to reduce variance.

At 610, the method 601 may include, once the scanning of the object is completed, storing the invariant features in a dataset and/or querying the resulting dataset of stored invariant features based on geometric features for matching associated with the indicated state of the object being scanned, resulting in highest accuracy match results within an error window based on the configuration of the query, such as within a certain width or within a certain length.

At 612, the method 601 may include performing template matching. For example, either before or after applying the suitable match filters, the corresponding trained parameters may be loaded based on the filtered results after identifying the resulting corresponding group IDs. Inference may be run on the supervised training, and the best match or matches, up to a predetermined number of matches, such as 10 best matches for example, may then be determined for those matches that are above a predetermined confidence level.

For example, assuming that the object to be identified is small model object sm1, the vision scanning may initially predict that the scanned object is small model object sm2 with 55 percent confidence, and therefore fetches the group ID (510 in FIG. 5) associated with object sm1 and loads the associated frozen graph model (516 in FIG. 5) for that group ID. The vision scanning may be performed for the associated frozen graph model (516 in FIG. 5) and, for example, may predict that the scanned object is identified as small model object sm1 with 85 percent confidence, is identified as small model object sm2 with 5 percent confidence and is likely small model object sm3 with 10 percent confidence. Therefore, the scanned object may be identified as being small model object sm1.

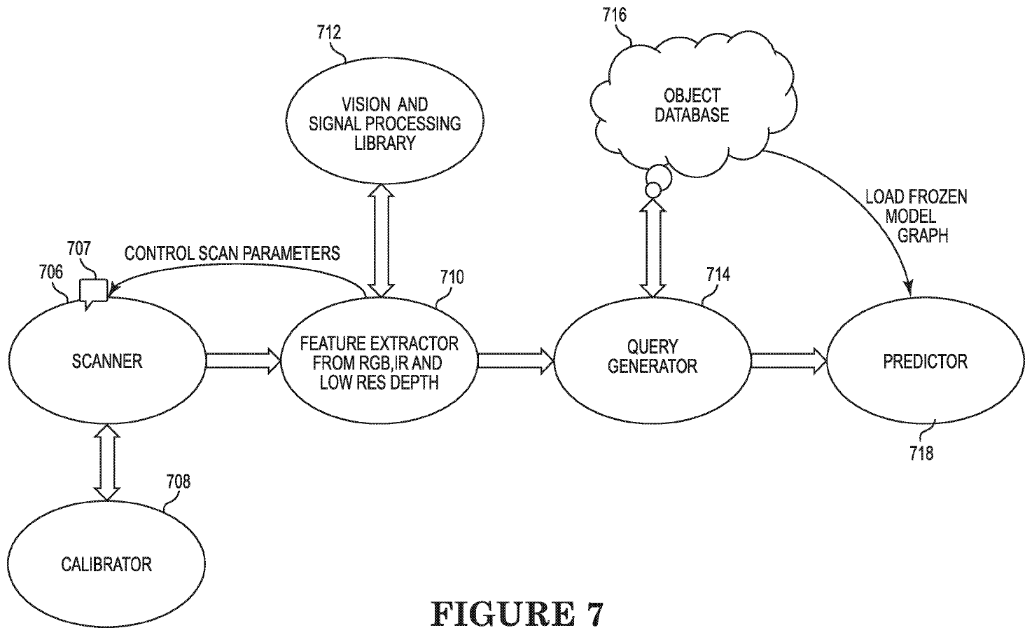

FIG. 7 is a schematic diagram of an example of an identification of an object from the object database consistent with the present disclosure. During subsequent identification of an object using the object database generated as described above, the user may input the state or condition of the object based on predetermined stages of degradation, as described above.

Scanning of the object may be initiated using a scanner 706. An input interface 707 may be included that enables information related to the object, such as condition of the object for example, to be input by the user during the scanning, as described above. A scan calibrator 708 may calibrate scale, skew and perspective of the scanned image. A feature extractor 710 may extract corresponding RGB data, IR data and depth data as the scan is performed in multiple orientations of the object. Vision processing procedures stored in a vision and signal processing library 712 may be received by the feature extractor 710. The vision processing procedures may be performed to fix the scale, skew orientation and perspective of the scanned object using an aligned axis, and to identify invariant and geometric/spatial feature vectors, such as maximum length, maximum width, cross-sectional area, centroid, convex hull, contour, etc. In addition, averaging may be performed over multiple scans to reduce variance.

Once the scanning of the object is completed, a query generator 714 may receive a group ID identifying the subset of objects within which the scanned object is determined to be included along with the corresponding trained parameters for the subset of objects from the generated object database 716. The query generator 714 may configure a query of the best match or matches associated with the scanned object included within the group of objects identified by the group ID and send the query to a predictor 718. Inference may be run based on supervised training by the query predictor 718, and the most relatively accurate match or matches, up to a predetermined amount, such as 10 best matches for example, are then determined for those matches that are above a predetermined confidence level.

For example, as described above, assuming that a subset of objects identified during the generation of the object database 716 includes 3 objects, objects sm1 to sm3 and therefore the corresponding group ID for the subset of objects is “sm”. If the object currently being scanned is object sm1, the query predictor 718 may initially predict, using the vision processing 712, that there is a 55% percent confidence level that the current scanned object may be object sm2. Therefore the query predictor 718 determines the group ID for the subset of objects within which object sm2 is included, loads the trained parameters located within the frozen graph model results for the subset of objects having the determined group ID and performs vision processing 712 on the loaded trained parameters for the identified subset of objects, and determines the likelihood that the scanned object is either of objects in the subset of objects for the group ID. For example, the query predictor 718 may predict that there is an 85 percent chance that the current scanned object is object sm1, a 5 percent chance that the current scanned object is object sm2, and a 10 percent chance that the current scanned object is object sm3. As a result, since the chance that the current scanned object is object sm1 is greatest, and is above a given threshold, say 70 percent for example, the current scanned object is identified by the query predictor 718 to be object sm1.

In this way, the identifying of an object using a generated object database may include scanning the object to be subsequently identified, performing a scan calibration during the scanning, adjusting the scanning using a vision processing procedure, performing background subtraction and object segmentation, determining a subset of objects in which the scanned object may be included, and receiving a group identifier associated with a subset of objects along with the corresponding trained parameters within a frozen graph model for the determined subset of objects. Vision processing may be performed on the corresponding trained parameters to determine one or more best matches between the object to be identified and the objects included within the subset of objects associated with the received group identifier. The scanned object may be identified based on a resulting best match of the determined one or more best matches.

In another example, identification of an object using a generated objects database may include scanning the object to be subsequently identified and receiving input from a user as to a condition of the object to be identified so that identification of the scanned object is performed based on both the scanning of the object and the received input condition of the object to be identified. The performed identification may include scanning the object to be identified, receiving the input condition, performing a scan calibration during the scanning, adjusting the scanning using a vision processing procedure, performing background subtraction and object segmentation, determining a subset of objects in which the scanned object may be included, and receiving a group identifier associated with the determined subset of objects and the corresponding trained parameters stored within a frozen graph model from the for the determined subset of objects. Vision processing may then be performed on the corresponding trained parameters to determine one or more best matches between the object to be identified and the objects included within the determined subset of objects associated with the received group identifier. The scanned object may then be identified based on a resulting best match of the determined one or more best matches, as described above.

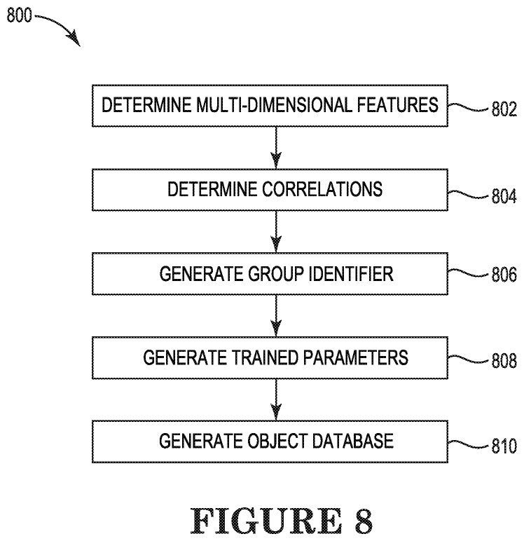

FIG. 8 is a flowchart of an example of a method 800 of generating an object database consistent with the present disclosure. At 802, the method 800 may include determining multi-dimensional orientations and geometric properties of features. The determination may be utilized to generate a subset of objects from objects included in a pre-existing object database that are unique to the subset of objects.

At 804, the method 800 may include determining correlations between the determined multi-dimensional invariant orientation and the geometric properties of the features. At 806, the method 800 may include generating a group identifier for the subset of objects.

At 808, the method 800 may include performing supervised training on the determined multi-dimensional invariant orientation and geometric properties. The supervised training may be performed in order to generate trained parameters of the subset of objects. Performing the supervised training may include utilizing a convolutional neural network training on the determined multi-dimensional invariant orientation and geometric properties of the subset of objects.

At 810, the method 800 may include generating an object database for the subset of objects. The object database may be generated based on the generated group identifier and the generated trained parameters for the subset of objects.

In the foregoing detailed description of the present disclosure, reference is made to various examples of methods and systems consistent with the present disclosure. No one example is meant to be taken in a strictly limiting sense. Instead it is contemplated that elements from any example described above may entirely or selectively be combined with any other example described above. Additionally, it is contemplated that any example given above may be performed by executing, by a processing resource, corresponding instructions stored on a non-transitory computer readable medium.

In the foregoing detailed description of the present disclosure, reference is made to the accompanying drawings that form a part hereof, and in which is shown by way of illustration how examples of the disclosure can be practiced. These examples are described in sufficient detail to enable those of ordinary skill in the art to practice the examples of this disclosure, and it is to be understood that other examples can be utilized and that process, electrical, and/or structural changes can be made without departing from the scope of the present disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure and should not be taken in a limiting sense.

What is claimed is:

1. A system, comprising:
a scanning device to scan a plurality of objects in a controlled environment and in multiple orientations;
a scan calibrator to perform calibration of the scanning by the scanning device; and
a database configurator configured to determine multi-dimensional invariant orientations and geometric properties of features of the scanned objects to generate subsets of objects from the plurality of objects that are unique to the subset of objects, determine correlations between the determined multi-dimensional invariant orientation and the geometric properties of the features, generate group identifiers for each of the subsets of objects, perform supervised training on the determined multi-dimensional invariant orientations and geometric properties to generate trained parameters for each of the subsets of objects, and generate an object database based on the group identifiers and the trained parameters.

2. The system of claim 1, wherein the scan calibrator calibrates at least one of scale, skew and perspective of a scanned object of the plurality of scanned objects.

3. The system of claim 1, wherein background and light conditions during the scanning are known by the database configurator.

4. The system of claim 1, wherein the scan calibrator adjusts the scanning by the scanning device using vision processing.

5. The system of claim 1, further comprising:
a feature extractor to extract features of a scanning of an object of the plurality of objects to be identified from the generated object database and determine a group identifier of the generated group identifiers corresponding to the object to be identified based on the extracted features; and
a query generator to receive the determined group identifier for the object to be identified from the feature extractor, determine matches of the object to be identified based on the trained parameters for the determined group identifier, and identify the object of the plurality of objects to be identified based on the determined matches.

6. The system of claim 5, further comprising an input interface to receive input corresponding a condition of the object to be identified, wherein the feature extractor determines the group identifier of corresponding to the object to be identified based on the extracted features and the input received from the input interface.

7. A method of generating an objects database, comprising:
scanning a plurality of objects to be included within the generated object database;
determining multi-dimensional invariant orientations and geometric properties of features of the scanned plurality of objects;
determining correlations between the determined multi-dimensional invariant orientations and the geometric properties of features;
generating subsets of objects comprising objects having similar features that are unique to each of the objects included within the subsets of objects based on the determined correlations;
generating a group identifier for each of the generated subsets of objects;
performing supervised training on the determined multi-dimensional invariant orientations and geometric properties to generate trained parameters for each of the subsets of objects; and
generating the object database based on the group identifiers and the generated trained parameters.

8. The method of claim 7, further comprising:
scanning each of the objects to be included in the generated object database in a controlled scanning environment; and
performing scan calibration during the scanning of each of the objects.

9. The method of claim 8, wherein background and light conditions during the scanning of each of the objects are known.

10. The method of claim 8, further comprising adjusting the scanning of each of the objects using vision processing.

11. The method of claim 10, further comprising using the vision processing to perform background subtraction and object segmentation during the scanning of each of the objects.

12. The method of claim 7, further comprising:
scanning an object to be identified from the generated object database;
extracting features of the scanned object to be identified from the generated object database;
determining a group identifier of the generated group identifiers corresponding to the scanned object to be identified based on the extracted features;
determining matches of the scanned object to be identified based on the trained parameters for the determined group identifier corresponding to the scanned object to be identified; and
identifying the scanned object to be identified based on the determined matches.

13. The method of claim 12, further comprising receiving input corresponding a condition of the object to be identified, wherein the group identifier corresponding to the scanned object to be identified is determined based on the extracted features and the received input.

14. A system comprising:
a scanning device to scan an object to be identified from an object database comprising a plurality of objects;
a feature extractor to extract features of the scanning of the object to be identified and determine a group identifier identifying a subset of objects having features that are unique to the subset of objects corresponding to the scanned object to be identified based on the extracted features; and
a query generator to receive the determined group identifier for the object to be identified from the feature extractor, determine matches of the object to be identified based on trained parameters generated for the determined group identifier, and identify the object to be identified based on the determined matches.

15. The system of claim 14, further comprising an input receiver to receive input corresponding a condition of the object to be identified, wherein the feature extractor determines the group identifier of corresponding to the object to be identified based on the extracted features and the input received from the input interface.

16. The system of claim 14, further comprising:
a scan calibrator to perform calibration of the scanning by the scanning device; and
a database configurator configured to generate the group identifiers.

17. The system of claim 15, wherein the database configurator is configured to determine multi-dimensional invariant orientations and geometric properties of features of the scanned objects to generate the subsets of objects from the plurality of objects that are unique to the subset of objects.

18. The system of claim 17, wherein the database configurator is configured to determine correlations between the determined multi-dimensional invariant orientation and the geometric properties of the features, generate the plurality of group identifiers, and perform supervised training on the determined multi-dimensional invariant orientations and geometric properties to generate trained parameters for each of the subsets of objects.

19. The system of claim 15, wherein background and light conditions during the scanning are known by the database configurator.

20. The system of claim 15, wherein the scan calibrator adjusts the scanning by the scanning device using vision processing.
